(19) United States
(12) Patent Application Publication
(10) Pub. No.: US 2006/0064320 A1
(43) Pub. Date: Mar. 23, 2006

(54) System and method for centralized management and monitoring of healthcare services

(76) Inventor: Richard Postrel, Miami Beach, FL (US)

Correspondence Address: ANTHONY R. BARKUME, 20 GATEWAY LANE, MANORVILLE, NY, 11949, US

(21) Appl. No.: 11/144,377

(22) Filed: Jun. 2, 2005

Related U.S. Application Data
(60) Provisional application No. 60/576,634, filed on Jun. 2, 2004.

(51) Int. Cl. G06Q 10/00

(52) U.S. Cl. 705/2

(57) ABSTRACT

A centralized healthcare management and monitoring system and service including a healthcare management server computer interconnected to a computer network, having a first repository of records with patient healthcare information and a second repository with predetermined compliance rules with information regarding an interaction between multiple entities associated with the healthcare management server computer. Multiple healthcare provider computers, associated with a healthcare provider, allow input of patient identification indicia identification indicia presented by a patient and communicating with the healthcare management server computer over the computer network. A query is sent to the healthcare management server computer that includes the patient identification indicia; an identification of the healthcare services performed or proposed to be performed by the associated healthcare provider; and an identification of the healthcare provider performing the healthcare services. The healthcare management server computer then utilizes the query to access the first and second repositories to determine if the parameters of the query are in compliance with one or more of the predetermined compliance rules.

### CROSS-REFERENCE TO RELATED APPLICATION

This application claims filing priority of co-pending U.S. provisional patent application Ser. No. 60/576,634, filed on Jun. 2, 2004.

### BACKGROUND OF THE INVENTION

The present invention relates to the provision of medical and related management and monitoring services, and in particular to a centralized method and system for managing and monitoring healthcare services, payments, costs, risks, quality control, and performance measurement.

The healthcare industry today is a complicated and fragmented system. People at different times require the services of various types of healthcare providers, such as doctors, home care nurses, dentists, surgeons, therapists such as physical therapists and the like. People will utilize these services as needed or on an emergency basis, or often on recommendations of others. As a result, people will tend to use such healthcare providers that have no relationship with one another, which results in fragmented health care management. For example, a person may have medical records on file with a general practitioner doctor, a number of specialists, their dentist, etc. This can lead to redundancy of paperwork, increased human error, which in turn can lead to mistakes in providing care, for example when one healthcare service provider does not have a complete record of a patient's medical history and makes an incorrect diagnosis or recommendation as a result. Mistakes can also occur when a patient visits a new doctor and provides erroneous background information. Expenses are driven upwards when healthcare service providers try to obtain prior records such as x-rays, etc. in order to dispense treatment. These issues also lead to delay in obtaining treatment. As a result, many people will not seek appropriate medical treatment (including preventative care and maintenance) because it is too inconvenient, cumbersome, confusing, and time-consuming.

The patient-specific issues mentioned above are also problematic from the viewpoint of the healthcare service provider. In addition, the healthcare service provider is usually paid by a health insurance company or other third party (such as a credit union), which adds many more problems such as inordinate delays in getting paid, increased paperwork, and even nonpayments in some cases. This increases the cost of providing services and takes away the providers' time that could otherwise be spent tending to their patients.

Healthcare insurers also face problems such as insurance fraud (for example where claims are made for services not rendered, excessive testing, improper prescriptions, etc.) and the increased cost of processing the insurance claims from the healthcare service providers as well as patients.

Healthcare service centers such as hospitals, as well as their patients, also face similar problems. Persons desiring to obtain medical care, for example in an emergency situation, often encounter long delays in getting appropriate treatment. Delays may be attributed to several factors. One factor is the requirement for a patient to fill out forms at the emergency room intake, including personal information (e.g. name, address, telephone number), past medical history, and insurance information. This type of information is static since it generally does not change based on the emergency at hand. Other information that must be provided is situation-specific, such as the symptoms encountered by the patient at the time of the particular visit to an emergency room or other health care provider. Delays are further encountered when the emergency room personnel must process the information provided by the patient, such as when they must verify the validity of the insurance information given.

Delays such as these can have significant consequences in situations where care must be immediately provided. Even in those non-emergency situations, long delays in obtaining appropriate care is undesirable.

It is therefore desired to provide a centralized healthcare management and monitoring service that interoperates with subscribers to the service, who may be patients, healthcare providers, healthcare institutions, governmental agencies, pharmacies, pharmaceutical companies, and insurance companies, in order to promote a patient's well-being, reduce their anxiety, and generally to overcome these problems of the prior art.

It is a further object of the invention to provide such a centralized healthcare management and monitoring service that can manage all of the transactions between these parties to reduce costs, increase speed of payment, and reduce if not eliminate payment on fraudulent claims.

It is a further object of the invention to provide such a centralized healthcare management and monitoring service that reduces medical history management burdens by providing a centralized repository of patients' medical histories that is secure, easily accessed by authorized parties, and easily modified as diagnoses are made and treatments are rendered.

It is a further object of the invention to provide such a centralized healthcare management and monitoring service that utilizes a portable token such as a healthcare card for identifying carriers thereof as subscribers to the system, enabling for example the patient/subscribers to receive priority health care in conjunction with the system.

It is a further object of the present invention to utilize the aforementioned healthcare card to quickly access the patient's medical records from the repository, view the medical records, and modify the medical records as authorized by the system.

It is a further object of the invention to provide a system that enables aggregation or batching of products or services in the healthcare field and thus provide efficient and cost-effective treatment of patients.

It is a further object of the invention to provide a centralized healthcare management and monitoring service that provides monitoring of procedures, costs, payments, etc. to ensure compliance with a variety of rules, regulations and medical standards.

It is a further object of the invention to provide a centralized healthcare management and monitoring service that provides incentive to participants in the form of health performance and reward points that may be earned for participating in health-related activities and/or for maintaining a healthy lifestyle, and which allows a participant to accumulate such health points and redeem them towards a variety of awards such as reduced insurance premiums.

It is a further object of the invention to reduce insurance costs and reduce risks by implementing proactive procedures and preventative and maintenance care activities.

### SUMMARY OF THE INVENTION

The present invention is a seamless end-to-end solution involving all participants, i.e. patients, health care providers and institutions, and insurance companies. The present invention is a centralized healthcare management and monitoring system and service that includes several main components operating over a computer network such as the Internet. A healthcare management server computer is interconnected to the computer network, and includes a first data repository of patient records, each patient record associated with a patient who is a subscriber to the system and accessible via a unique patient identification indicia associated with the patient, each patient record comprising healthcare information associated with the patient. A second data repository includes sets of predetermined compliance rules, each of the compliance rules having information regarding an interaction between multiple entities associated with the healthcare management server computer. For example, a compliance rule might state that a pregnant woman should have a sonogram procedure in the fifth month of pregnancy.

A plurality of healthcare provider computers is also interconnected to the computer network, each of which is associated with a healthcare provider such as a doctor who is a subscriber to the system. Each of the healthcare provider computers has means for inputting a patient identification indicia presented by a patient and communicating with the healthcare management server computer over the computer network using the patient identification presented by the patient. Thus, when a patient presents, in association with healthcare services performed by the associated healthcare provider, a patient identification indicia associated with the patient, the healthcare provider computer transmits to the healthcare management server computer a query including the following parameters: the patient identification indicia; an identification of the healthcare services performed or proposed to be performed by the associated healthcare provider; and an identification of the healthcare provider performing the healthcare services. The healthcare management server computer then utilizes the query to access the first and second data repositories to determine if the parameters of the query are in compliance with one or more of the predetermined compliance rules.

For example, the compliance rules may be related to healthcare treatment procedures, and the healthcare management server computer determines if the healthcare services proposed to be performed by the healthcare provider identified in the query are in compliance with the specified healthcare treatment procedures. In addition, the healthcare information associated with the patient identified in the query may be utilized by the healthcare management server computer to determine if the healthcare services proposed to be performed by the healthcare provider identified in the query are in compliance with the healthcare treatment procedures as adapted for that particular patient.

In a further embodiment, a healthcare insurer computer associated with a healthcare insurance provider may also be in communication with the healthcare management server computer, either directly or via the computer network. The healthcare management server computer obtains insurance information from the healthcare insurer computer and utilizes the insurance information to determine if the parameters of the query are in compliance with one or more of the predetermined compliance rules. The insurance information may include information related to an insurance payment that the healthcare insurance provider agrees to pay for the proposed healthcare services. The insurance payment may be made by the healthcare insurance provider to the healthcare provider based on the healthcare services rendered by the healthcare provider to the patient.

In addition to specific patient treatment guidelines, the compliance rules may include rules promulgated by a governmental agency, or by a healthcare administrative agency.

Thus, accountability to standards of care and compliance with existing rules is enabled by the present invention and essentially forced on participants to the system.

A token may be used to encode the unique identification indicia for identifying the associated patient. Typically, the token may be in the form of a healthcare card, which may have a magnetic stripe encoded with the patient identification indicia, or which may be a smart card comprising storage means for storing at least the patient identification indicia. The token may also be an object such as RFID device capable of subdermal implantation. Other subscribers such as doctors may carry healthcare cards encoded with indicia identifying them as subscribers to the healthcare system.

The healthcare provider computers may comprise means for inputting data, such as keyboards, scanners and the like, wherein revised healthcare information is entered into the healthcare provider computer and transmitted to the healthcare management server computer, and the record(s) in the data repository associated with the patient are modified to include the revised healthcare information.

In another aspect of the invention, the healthcare management server computer may include or have access to a third data repository of health point account records associated with each of the patients, the health point account records containing a health point account that indicates a number of health points that have been awarded to the patient based on one or more of a plurality of health-related criteria. For example, health points may be awarded to a patient for participating in a positive health-related activity (such as joining a health club), or for not participating in a negative health-related activity (such as smoking). Health points may also be awarded to a patient for maintaining a predetermined level of health (such as being at a goal weight or having exemplary blood pressure).

Multiples of health points may be accumulated in the health point account, and a patient may redeem accumulated health points from the associated health point account in exchange for one of a plurality of available benefits such as reduced insurance premiums.

### BRIEF DESCRIPTION OF THE DRAWING

FIG. 1 is an illustration of the healthcare management and monitoring system of the preferred embodiment of the present invention;

FIG. 2 is an illustration of the healthcare management server of FIG. 1; and

FIG. 3 is an illustration of the query sent to the healthcare management server of FIG. 1.

### DETAILED DESCRIPTION OF THE PREFERRED EMBODIMENT

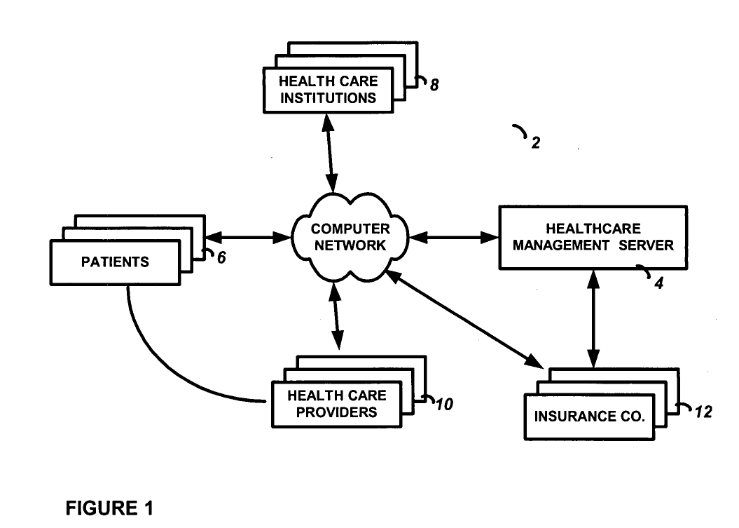

The present invention is a method and system for providing priority-based healthcare management and monitoring services to various subscribers of the system. A subscriber may be a patient, a healthcare provider such as a doctor, a healthcare institution such as a hospital, an insurance company, or a governmental agency. As shown illustratively in FIG. 1, the system 2 implements a centralized health care management server computer 4 that manages interactions amongst patients 6, health care providers 10 (such as doctors, therapists, dentists, as well as non-licensed caregivers), health care institutions 8 (such as hospitals), and the health insurance companies 12. In particular, the healthcare management server computer 4 is an intermediary between these parties in accordance with the transaction being executed. For example, when a patient requires emergency room treatment, the healthcare management server computer 4 will be a liaison between the patient and the health care institution, between the health care institution and the insurance company, between the patient and the health care provider, etc. These interactions are explained in further detail herein.

In addition to being a liaison between the above parties for such transactions, the healthcare management server computer 4 provides a centrally located medical and insurance data repository that can be accessed by all authorized parties in order to easily ascertain a patient's medical history, for example. As described herein, this medical record repository provides a streamlined methodology for ensuring that medical information is accurate, timely, and easily accessed and revised.

A person may become a member of the system 2 by subscribing to the services offered to consumers by the health care management server computer 4. That is, with respect to consumers, the system is subscription based, wherein a consumer becomes a patient subscriber by paying an enrollment and/or periodic membership fee and/or transaction fee to the healthcare management service 4, which may be operated by the insurance company, medical practice, or other financial or other services entity. The patient will register with the healthcare management service 4 either directly or via a participating health care institution 8 (such a local hospital), or via a participating health care provider (such as the family doctor), or via their health insurance company 12. Once registered with the system 2, it may be preferred for the patient 6 to always use the priority services of his local health care institution 8 but is also able to use the priority services of other health care institutions 8. For example, the patient may chose at any given time to use a different health care provider, or if the patient is traveling he may be required to use a different health care provider.

In addition to individual patients subscribing to the system, families of subscribers are also contemplated to enroll. Data may be collected, stored and analyzed for these families (natural, extended or otherwise) to help in providing appropriate diagnosis, treatment, etc. Furthermore, geocentric components of a subscriber may also be logged in order to analyze location-based indicia such as high occurrences of an environmentally effected disease (e.g. breast cancer). Detailed analysis of location based patient data can help to uncover risk factors and develop treatment plans accordingly. Also, these data can lead to intelligent predictive analysis that can be stored in patients' profiles in the database 14.

The present invention allows integration and analysis of patient data such that candidates for research projects may be selected from the database based on various criteria of the project. For example, a need for sleep-deprived subjects in a medical study may be met be simply querying the databases of the management server to find patients with that characteristic.

The health care management service may operate in the financial services area as a factor or guarantor of payments to all members and subscribers of the system. A third party financial services institution may be a part of the system and function as the payor for products and services administered under the system, as an adjunct to or in the alternative to typical insurance companies. Also, the present invention may operate on behalf of a self-insured entity in a closed or open environment.

A health care institution 8 such as a hospital may in some situations be the focal point of the value-added or extension services in this invention. For example, a hospital may already be setup to offer standard hospital services, such as emergency room care, surgical services, and general health care. Other extension services may be added, such as maternity care, neo-natal care, dentistry, orthodontia, etc. By forming alliances based on the hospital as the core service provider, the system achieves a synergy advantageous to patients as well as the health care providers 10 as described herein. Notably, independent health care providers may be incentivized to make alliances with a health care institution 8 under this system.

The hospital will implement computers that will interconnect to a central health care management server computer 4, which will manage the system of the present invention. The health care institution server 8 will provide value-added services as an application layer on top of existing health care provider/patient/insurer relationships. The health care management server 4, in addition to being interconnected to various hospital client computers, will also be interconnected to insurance server computers 12 operated by the health insurance companies. Thus, the health care management server 4 will act as a liaison between the hospitals and the insurance companies as described herein.

Each hospital will provide offers to users to become members of the network by paying an initial membership fee and filling out various forms that require input of personal information, medical history, insurance information, etc. This information may be input in various electronic forms available from the hospital via a web server over the Internet, or the patient may fill out paper forms and submit them to the hospital, which will enter the data directly or forward the forms to the health care service provider for entry. In the alternative, certain information such as existing insurance information may be automatically be accessed by communications with the insurance companies and used for this health care card. In any event, each patient will have their required information (personal, medical, insurance) entered into a central repository at the central healthcare management server. In addition, information such as DNA information may be included in the database of patient information for subsequent identification and/or analysis purposes.

After the patient becomes a subscriber to the system and provides the required information, then the system 2 will issue a membership card or other token to the patient, which may be in the form of any type of card known in the art such as a magnetic stripe card, a card having a bar code or RFID chip, a smart card, a stored value card, etc. The card will have basic information encoded thereon, such as a patient identification number. The identification number may be any indicia that uniquely identifies the patient, such as any arbitrary indicia or even the patient's unique Social Security number, which will allow integration with other databases that utilize the Social Security number. When the patient wishes to use the card, he presents it to a terminal at the hospital, and the appropriate card reading technology will be employed to read the identification number off of the card.

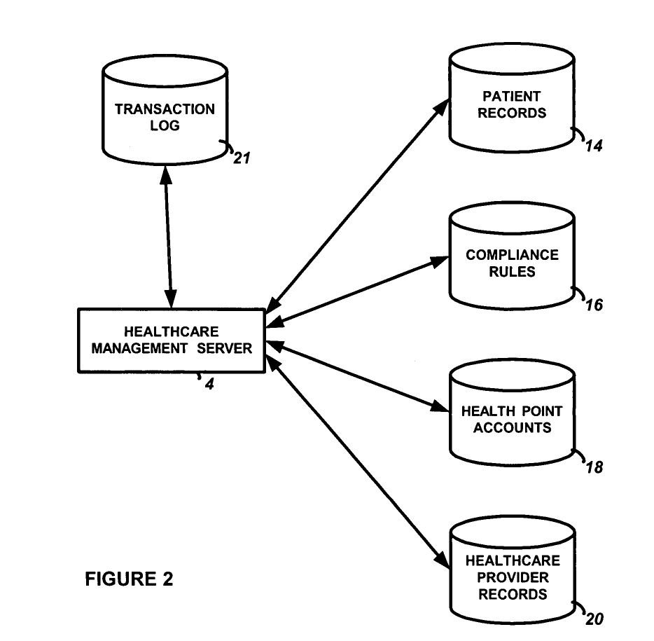

Thus, when a patient 6 requiring medical services presents the card to a terminal at the affiliated health care provider 10 or healthcare institution 8, the card will be read (and PIN, or other identification such as a password or biometrics, entered if desired) and the patient identification number will be transmitted, via a network connection such as the Internet, from the health care terminal to the health care management server 4. The healthcare management server 4 will use the identification number to look up the pertinent information for that patient from the data repository of patient records 14 (see FIG. 2) and interact with the health care institution server and/or insurance server as may be required, as further described herein.

The health care management server 4 may store in patient database 14 current insurance information for each of its patients, which may be updated periodically as desired (e.g. weekly, daily, etc.) In the alternative, the health care management server 4 may communicate with the appropriate insurance company 12 in real-time, as needed by the system to determine the scope of the coverage and get approval for treatment, if necessary. It also may be determined if human interaction or intervention is required. For example, if a patient requires an immediate emergency operation, then the health care management server 4 would query the insurance server 12 to ascertain the coverage amounts, as well any other pertinent information. A real-time query might provide greater accuracy of information than use of a local database at the health care management server.

Thus, all of the required insurance information as well as personal information and medical history information is retrieved from the patient repository 14 and sent from the health care management server to the health care institution (hospital) computer 8 or healthcare provider computer 10. There, online forms will be populated with the required data and all of the information will appear in the screen of the terminal being used at the hospital. Rather than having to manually enter each piece of information, the process provides for automatic input from the health care management repository 14, which provides for greater accuracy and increased speed. Records such as X-ray prints and the like may be digitized and stored digitally in the repository 14, and thus be accessible to anyone with a need to access them. A fee may be charged to the requesting party for transmitting them; for example, it may cost $20 to provide a set of x-rays that were taken in the past year of a healing bone fracture. These records would be immediately accessible to any authorized party for the specified fee, which may be charged and paid for by the appropriate payee (e.g. the insurance company). A patient is also able to access his medical information in this manner in a simple and efficient process. The patient may be able to access a web server at the healthcare management computer 4, enter his patient ID number, and then access his medical history accordingly.

Other benefits are provided to a patient of this priority care system. Since patient screening and intake is reduced substantially, the emergency room personnel can process the patient much faster and are able to provide expedited entry into a screening room, where they will receive the required medical attention. This service may also provide for tiered services, wherein certain patients (e.g. those paying a higher premium) will receive care prior to non-subscribers, as long as the non-subscriber is not in a life-threatening situation. This provides an incentive for patients to subscribe to the system since they will move to the head of the line faster than those who are not subscribers. This benefits hospitals since they can process these patients faster due to the automated data retrieval and form population.

By issuing priority health care cards as described herein, the hospital may be co-branded with the central service provider. Thus, a patient may have a “St. Luke's Hospital PRIORITY CARE Card” or the like, designating their primary hospital for health care services. This will immediately identify the patient as belonging to that primary hospitals' service upon entry to the emergency room. Different member hospitals would enter into agreements with each other and/or the central service provider to allow patients to use other hospitals (secondary hospitals) if necessary (e.g. while traveling), and the same information would be retrieved for that secondary hospital since they utilize the same system, forms, etc. Rules may be established wherein subscribers at secondary hospitals are given priority treatment over non-subscribers, but not over those subscribers at that hospital.

Revenue may be generated on a subscription basis, wherein a subscriber pays a periodic or one-time fee for being a member of the system. For example, a patient may pay a $20 yearly fee, or a doctor may pay a $500 one-time fee, etc. Likewise, transaction fees may be imposed by the healthcare management service, which may or may not be paid by the insurer.

The monitoring service of the present invention may now be described. In addition to storing the first data repository of patient healthcare records 14 as mentioned above, the healthcare management server computer has additional data repositories that store compliance information and rules 16, health point accounts 18, and healthcare provider records 20. The compliance rules are related to interactions between the multiple entities associated with the system, i.e. the patients, insurers, healthcare providers and institutions. The compliance rules may be based on information, rules and regulations promulgated by one or more various institutions, such as a healthcare insurance company, a governmental entity, etc. The compliance rules may set forth predetermined standards of care, such as standards of care for a pregnant woman (e.g. how many physician visits are appropriate, and at which intervals, which test should be administered and when, etc.). The compliance rules may also set forth standards of payment promulgated by an insurance company, such as which treatments are covered for particular ailments, etc. The compliance rules may encompass any predetermined standard, rule or regulation as may be applicable in the healthcare industry.

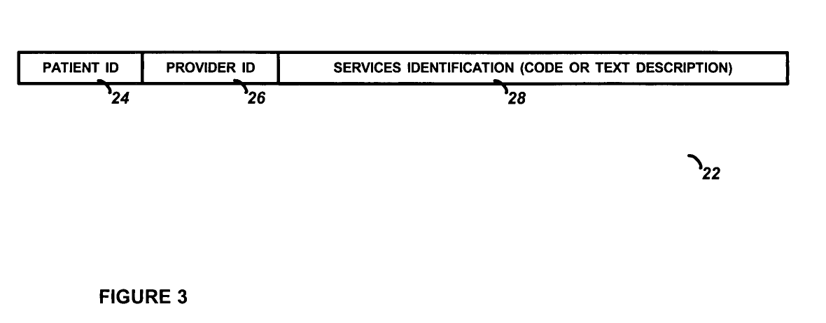

The monitoring service of the present invention will utilize some or all of the predetermined compliance rules in order to evaluate a proposed course of treatment or the like. Thus, when a patient presents his identification card to a healthcare provider such as a doctor, the healthcare provider will swipe the card into a terminal connected to a healthcare provider computer 10 located in proximity to the doctor's office. The patient's identification indicia will be read off of the card and a query 22 will be formulated by the healthcare provider computer. The query, as shown in FIG. 3, will be composed of the following components:
the patient identification indicia 24 as read off of the healthcare card (or other like token)
a description or other identification (e.g. code) 28 of the healthcare services that are being proposed to be administered by the healthcare provider or which have already been administered (such as a sonogram for a pregnant woman)
an identification 26 of the healthcare provider (e.g. the doctor's subscriber/ID number)

Optionally, other information may include the healthcare institution that may be involved (e.g. the name of a clinic or hospital),and other pertinent information regarding the condition of the patient. The query will thus at least have information that indicates who is about to administer a procedure, what the procedure is, and on whom the procedure will be administered (e.g. Dr. John Smith will perform a sonogram on Mrs. Mary Doe, who is in her fifth month of pregnancy).

The query 22 will then be transmitted by the healthcare provider computer 10 to the healthcare management server 4 computer over the computer network (i.e. the Internet). The healthcare management server computer 4 will receive the query 22 and then access the data repositories 14, 16, 18, 20 by using the query information. The healthcare management server computer 4 will in particular access the compliance rules 16 mentioned above to determine if the proposed course of treatment is acceptable under the circumstances. If the proposed treatment is in fact in compliance with the predetermined standards, then this will generate an approval message which will be transmitted back to the healthcare provider computer 10 and also stored in transaction log 21 for future reference. The healthcare provider will be informed that the proposed procedure has been approved and may then proceed as planned.

The insurance server computer 12 may also be included in this process to ensure that payment may be made on a timely basis by the insurance company to the healthcare provider. Once the process has been approved, then there is an assurance to the healthcare provider that payment will be made. The process may be completed when the healthcare provider indicates that the procedure has been administered, which may be confirmed by the patient as well. In addition, the patient may be asked to approve payment or may be asked to respond to an exit survey regarding the services rendered.

In another aspect of this invention, a health performance points program may be established by use of the healthcare card. A schedule will be generated that sets forth certain health related tasks, such as a yearly dental check-up, and an associated number of health points that would be awarded to a patient who completes that task. These tasks would promote well-being, including but not limited to dental check-ups, prostate examinations, breast examinations, vitamin purchases, cholesterol review, etc. The tasks would be based on a profile of requirements of the insurer or other participating entity. By awarding these health performance points, and tracking them via the healthcare card, the patient is incentivized to perform these tasks since they can be used to earn broader insurance benefits, discounts, or to reduce costs. In addition to the tasks mentioned above, health performance points may be awarded to individuals based on actual performance data. Thus, points may be awarded as a function of the patient's weight, in which patients at a goal weight would receive more points than someone who is overweight. Likewise, non-smokers would get points whereas smokers would receive no points or even have points deducted. Health points would be tracked in a health point account database 18 as shown in FIG. 2.

As mentioned, a patient that has reached a predetermined milestone of accumulated health performance points may receive favorable rates on health insurance premiums, since healthier patients (as measured by their accumulated health points) generally translate to lower insurance costs. Likewise, doctors and other health care providers may have their patients' reward points tracked so as to determine those doctors with healthier patients, at least as determined by their accumulated health point totals. Doctors with larger numbers of patients having more health points will be rewarded with health performance points of their own based on their patients' performances, and then by being provided with lower malpractice insurance costs based on a premise that a healthier patient will be less likely to require medical attention and thus less likely to be subject to medical procedures that are accompanied by risk of malpractice. This premise may be extended to hospitals that have doctors with relatively higher amounts of health performance points (based in whole or in part on their patients' point totals), which will then also receive lower insurance rates.

Thus, this health performance point system will provide a mechanism for risk management, by allocating lower costs of participation to those who can objectively demonstrate their lower risk factors via accumulation of health performance points.

An authorized subscriber, after logging in, may be given access to various data over the Internet by interconnecting with the central server database, and can modify the data as needed. In addition, the subscriber may be given a menu of plan options that may be reviewed and selected as desired. For example, a multi-tiered set of services may be offered (e.g. silver, gold, platinum), and the patient may choose or modify the desired plan. Payment may easily be made by any means known in the art, including but not limited to credit card, smart card, debit card, stored value card, or check.

The patient may also be able to access various accounts via his priority care card, such as insurance accounts, and modify those accounts online. For example, by using his card to access his patient profile, the patient may be able to increase the amount of insurance he has (health, but also possibly automobile, life, property, etc.) in a given situation. A waiting period may be established before the modified insurance would be accepted, for instance to verify any changes in conditions of the insured party.

The present invention operates over a network (or set of independent networks) as illustrated in FIG. 1 that interconnects the various parties mentioned herein. In one embodiment, the approval and payment processes operate over a separate network that may piggyback the existing credit card infrastructure and operate in a similar manner, wherein parties request and obtain approval for health transactions in the same manner that banks interoperate over the credit card network. A separate information network, such as the Internet, could also be utilized to interconnect the various entities to provide information flows therebetween, such as when a patient logs onto the system to access his medical records. In another embodiment, a single network such as the Internet may be used to accomplish all functionality if desired.

The patient's profile, as stored at the health care management repository 4, may have various levels of access proscribed in order to provide desired levels of privacy to the patient. For example, there may be three levels of access defined; highly confidential, moderately confidential, and non-confidential. The fact that a patient may have a disease such as AIDS may be classified as highly confidential, but his blood type may only be classified as non-confidential, etc. Then, in a given situation, rules would be defined that would allow certain persons access to only the non-confidential information, for example, and not the highly confidential information. Each health care provider or authorized person would have a security level assigned to them, and they would be required to enter their ID code at the time information is requested. The patient profile and rules would determine which information that person should have access to, and transmit only that information accordingly. These rules may be modified in emergency situations, which are also defined by predetermined rules.

The subscriber may also enter the names and contact information for emergency contact persons, such as a spouse, parent, or child. This can also easily be modified at the central server web site in patient database 14. When a patient presents the card to the emergency room at the hospital, the emergency contact information will be retrieved from the central server database 14 and the hospital may use this information to manually or automatically contact the designated person. For example, a patient may specify that in the event of an emergency room visit, certain people (such as his spouse and parents) must be notified, and their contact information is provided. The specific persons contacted may depend on the level of the emergency, e.g. his parents are only notified in an extreme emergency, or if his spouse cannot be reached. The central service or a third party may be utilized to perform these services as well. Other events may be triggered well. For example, in the event that a person is admitted to a hospital, the patient's profile may indicate that the local post office should be contacted to halt mail delivery, the news carrier should likewise be contacted to halt newspaper delivery, etc. This is particularly useful for those living alone, such as the elderly, who would not have someone at home that could take care of these events.

The storage facility at the healthcare management server 4 is designed to be especially secure and robust, given the confidential nature of the data being stored, accessed and revised. Certain governmental regulations have been promulgated to ensure data integrity and data storage safety and security, and the present invention complies with such regulations.

Value-added services could also be instituted and triggered by events as indicated in a patient's profile. A further example would be a service that provides meals to the elderly or infirm.

By utilizing the present invention, payments may be made in an expedited fashion to the health care providers and health care institutions. The healthcare management service may opt to provide quick payment to the recipients in exchange for an agreed-to discount, which may be on a sliding scale. For example, the management service may provide next day payment in the amount of 92% of the fees, with the remaining 8% being retained as a transaction fee. That is, on a $1,000 bill that would be covered by insurance, the management service would pay the recipient $920 the day after the service is rendered. The management company would be assigned to the right to collect the full payment from the insurance company ($1,000) and would retain the $80 difference as a transaction fee. Payment may not be made by the insurance company for a prolonged period of time, but this is what the transaction fee is intended to account for. The percentage may change as a function of delay in payment, so for example if the recipient is willing to receive payment from the management service one week later rather than one day later, they may get 94%, or if they take payment one month later they may receive 96%, etc. Other alternatives may be used, such as providing certain discounts based on volume, or on a sliding time scale, etc. These terms of payment would be agreed to by the parties contractually. The health care providers may indicate in a profile, for example at registration, their preferred form of payment, which may be modified as specified by the system.

This invention solves various problems for all of the parties that interact in the current medical care environment. Doctors and other health care providers will benefit by obtaining payment for their services in a timely manner, and by having reduced paperwork and operating costs. Patients will no longer suffer from lack of information about their past and current medical conditions as well as future requirements, and the lack of timely, attentive services in this area. Insurers will be able to obtain better records, patient and doctor information, and accounting records, and will be able to enforce rules and manage providers and patients better in order to reduce risks and their attendant costs.

In one embodiment, card reading terminals may be strategically located at various physical locations at a given health care institutions or premises of health care providers, The patient may be required to swipe his priority care card upon entering an examination room, for example, in a doctor's office. The doctor may also be required to enter his ID code into the system upon starting and ending the treatment. Thus, the health care management server would have a record of when the patient received his treatment. This information may be used to combat fraudulent claims, for example if a health care provider makes a fraudulent claim that a patient visited his office for treatment on a day when there is no log of such visit according to the terminal data. Furthermore, once the patient swipes his card into the reader, his medical records may be retrieved from the repository 14 and made available to the doctor in the examination room. This would expedite treatment since, by the time the doctor actually enters the examination room to make an analysis and dispense treatment, the medical records would be displayed on a screen of a networked computer. The doctor would use that information during his analysis, and then may be able to enter modified data to update the medical records 14 in accordance with the treatment being given at that time.

Any type of device that will enable a user to interconnect to the system, enter data and receive information back from the healthcare management server may be used in addition to computers as shown in the Figures. Thus, handheld wireless devices such as cell phones, PDAs, etc. are envisioned to be interoperable with the system of the present invention.

In a further embodiment, the doctor may make a drug prescription while the patient is being treated and enter it into his computer, which would be uploaded into the patient's file 14 at the central data repository. This prescription may then be automatically downloaded to a pharmacy previously designated by the patient, where the pharmacist would be able to prepare the medication for pickup by the patient upon presentment of the priority care card. In the alternative, the prescription would be held at the healthcare management server and then when the patient arrives at any participating pharmacy and presents his priority care card, the prescription would be retrieved and fulfilled.

This also provides for the ability to keep track of the usage of pharmaceuticals and other medical supplies, and enable an automatic or semi-automatic ordering system whereby supplies that are tracked via the system as being in low supply are ordered and restocked accordingly.

The present invention provides for marketing of products and services by participants. For example, a health care provider that administers prenatal care to a patient would be able to market appropriate products to that patient either at the time of treatment or before or afterwards.

In addition to the parties mentioned herein, other third party providers that are not subscribers to the system may be enabled to plug-in and interoperate with the system as long as certain security constraints are adhered to. Payment mechanisms would be employed to ensure that such non-registered third party participants make appropriate financial payments in exchange for interoperating with the system.

As previously mentioned, the priority care card may be in the form of a magnetic stripe or bar coded card, in which case the information embedded in the card would be minimal—likely only an identification number and/or name—and the patient's information, medical records, profiles, etc., would all be kept at the central repository 14. The card would be used to access all of the pertinent information as well known in the art. In an alternative embodiment, a smart card or stored value card may be used, which advantageously carries memory and/or processing circuitry as known in the art. In this case, much more information may be carried by the card for local applications where the central repository is not easily accessed. Furthermore, the data stored on the card may be modified by the local terminal in accordance with the application parameters. For example, it would be possible to store health reward points, previously mentioned, in memory on the card rather than at the central repository. Thus, in the event that the card is used with applications that are not interoperable with the central server of this system, but which accept reward points as a universal currency, then the off-network application could use the reward points as currency for making purchases or achieving better benefits. That is, the local application could access the reward point account, make appropriate deductions (or additions), without having to contact the central server.

Another feature of the present invention provides for a medical audit process for patients. Each patient may have their own personal web page stored in database 14 at the health care management server, which may be accessible via any web browser after an initial log-in process. There, the patient may view all of his medical and insurance information, including but not limited to prior medical events (such as checkups, treatments, diagnoses, drug prescriptions, test results), insurance information (such as policies, claims made and status thereof, contact information), medication information such as expiration dates, etc. There will also be a timetable or schedule (a “medical calendar”) of recommended treatments that sets forth the various procedures recommended for that patient, such as prostate screening at age 45, etc. This may be generated in conjunction with the compliance rules in database 16. This will greatly enhance the patient's ability to manage his medical and insurance information in one centralized location. The patient will also be able to make changes in his policy coverage by interacting with the web server, which in turn will interact with the interconnected insurance companies as requested.

The present invention provides for a web site to be established at the healthcare management server that will enable a patient to view provider listings and obtain information regarding the various healthcare providers and institutions that are part of the system. The managements server can present information such as referrals, ratings, recommendations, qualifications, and the like, which will enable the patient to make informed decisions regarding their choice of healthcare provider based on this information. Thus, a patient may be able to determine that certain doctor is highly recommended for certain procedures but not for others. This also enable cost comparisons, which may be especially useful if the patient must pay for an appreciable part of the treatment (such as with deductibles, co-payments, etc.).

The health care card of the present invention and system with which it operates contemplates the integration with biological depositories such as blood banks, tissue banks, etc. The system may integrate with these entities so that a patient may for example make a blood donation and simply present his card to a terminal at the time of the blood donation. By identifying the person via the card, the system can look up the relevant data from the healthcare management server 4 such as name, blood type, and disease history. As long as that person shows no diseases on file that would deter the blood bank from accepting his blood as a donation, then the blood extraction proceeds. If however that person's medical history reveals a disease such as AIDS, then the operator will be alerted to that fact and the blood will not be accepted.

When a person makes a donation under this embodiment, the donation will be noted on his account. Health reward points may be awarded and added to the patient's account in database 18 for the blood donation. The blood itself that is donated may also be tracked to that person via his identification card. The information may be stored on the central server and accessed via identification of the card presented, or the data may be stored on the card itself and updated accordingly, such as with a stored value card, a smart card and the like.

A further embodiment of the system provides for an implantable token such as a subdermal implant that is encoded with information that links to the system in the same manner as the health care card previously described. By using an appropriate reader, the health care provider may quickly ascertain the medical history, records etc. of the carrier without requiring them to physically present the card. This is quite useful in emergency situations, such as in a battlefield, where the wounded patient is unable to speak with the doctor or present his card. In the event that the patient has no wallet or other means of carrying a card, the subdermal implant will link the doctors to the same information stored in the system.

I claim:

1. A centralized healthcare management and monitoring system comprising:
a. a healthcare management server computer interconnected to a computer network, the healthcare management server computer comprising:
i. a first repository of patient records, each patient record associated with a patient and accessible via a unique patient identification indicia associated with the patient, each patient record comprising healthcare information associated with the patient; and
ii. a second repository of predetermined compliance rules; each of the compliance rules comprising information regarding an interaction between multiple entities associated with the healthcare management server computer;
b. a plurality of healthcare provider computers interconnected to the computer network, each of which is associated with a healthcare provider, each of the healthcare provider computers comprising means for inputting a patient identification indicia presented by a patient and communicating with the healthcare management server computer over the computer network using the patient identification presented by the patient;
wherein, when a patient presents, in association with healthcare services performed by the associated healthcare provider, a patient identification indicia associated with the patient, the healthcare provider computer transmits to the healthcare management server computer a query comprising parameters comprising:
the patient identification indicia;
an identification of the healthcare services performed or proposed to be performed by the associated healthcare provider; and
an identification of the healthcare provider performing the healthcare services; and
the healthcare management server computer utilizes the query to access the first and second repositories to determine if the parameters of the query are in compliance with one or more of the predetermined compliance rules.

2. The system of claim 1 wherein the compliance rules comprise rules related to healthcare treatment procedures, and wherein the healthcare management server computer determines if the healthcare services proposed to be performed by the healthcare provider identified in the query are in compliance with the healthcare treatment procedures.

3. The system of claim 2 wherein healthcare information associated with the patient identified in the query is utilized by the healthcare management server computer to determine if the healthcare services proposed to be performed by the healthcare provider identified in the query are in compliance with the healthcare treatment procedures.

4. The system of claim 1 further comprising a healthcare insurer computer associated with a healthcare insurance provider interconnected to the computer network.

5. The system of claim 4 wherein the healthcare management server computer obtains insurance information from the healthcare insurer computer and utilizes the insurance information to determine if the parameters of the query are in compliance with one or more of the predetermined compliance rules.

6. The system of claim 5 wherein the insurance information comprises information related to an insurance payment that the healthcare insurance provider agrees to pay for the proposed healthcare services.

7. The system of claim 6 wherein the insurance payment is made by the healthcare insurance provider to the healthcare provider based on the healthcare services rendered by the healthcare provider to the patient.

8. The system of claim 1 wherein the compliance rules comprise rules promulgated by a governmental agency.

9. The system of claim 1 wherein the compliance rules comprise rules promulgated by a healthcare administrative agency.

10. The system of claim 1 wherein the healthcare provider computer additionally retrieves from the healthcare management server computer healthcare information associated with the patient and presents the healthcare information.

11. The system of claim 1 further comprising a plurality of tokens, each of which is associated with a patient, and each of which is encoded with the unique identification indicia for identifying the associated patient.

12. The system of claim 11 wherein the token is a healthcare card.

13. The system of claim 12 wherein the healthcare card is a card comprising a magnetic stripe encoded with the patient identification indicia.

14. The system of claim 12 wherein the card is a smart card comprising storage means for storing at least the patient identification indicia.

15. The system of claim 11 wherein the token is an RFID device capable of subdermal implantation.

16. The system of claim 1 wherein the healthcare provider computers each comprise means for inputting data, wherein
a. revised healthcare information is entered into the means for inputting data and transmitted to the healthcare management server computer, and
b. the record in the repository associated with the patient is modified to include the revised healthcare information.

17. The system of claim 1 further comprising a third repository of health points account records associated with each of the patients, the health point account records containing a health point account that indicates a number of health points that have been awarded to the patient based on one or more of a plurality of health-related criteria.

18. The system of claim 17 wherein health points are awarded to a patient for participating in a positive health-related activity.

19. The system of claim 17 wherein health points are awarded to a patient for not participating in a negative health-related activity.

20. The system of claim 17 wherein health points are awarded to a patient for maintaining a predetermined level of health.

21. The system of claim 17 wherein multiples of health points are accumulated in the health point account.

22. The system of claim 17 wherein a patient may redeem accumulated health points from the associated health point account in exchange for one of a plurality of available benefits.

23. The system of claim 17 wherein the plurality of available benefits comprise reduced insurance premiums.

24. The system of claim 1 further comprising a third party financial services entity interoperable with the healthcare management server computer, said third party financial services entity functioning to make payment to the healthcare provider based on the healthcare services rendered by the healthcare provider to the patient.

25. A method of operating a centralized healthcare management and monitoring system comprising the steps of:
a. providing a healthcare management server computer interconnected to a computer network, the healthcare management server computer comprising:
i. a first repository of patient records, each patient record associated with a patient and accessible via a unique patient identification indicia associated with the patient, each patient record comprising healthcare information associated with the patient; and
ii. a second repository of predetermined compliance rules; each of the compliance rules comprising information regarding an interaction between multiple entities associated with the healthcare management server computer;
b. providing a plurality of healthcare provider computers interconnected to the computer network, each of which is associated with a healthcare provider, each of the healthcare provider computers comprising means for inputting a patient identification indicia presented by a patient and communicating with the healthcare management server computer over the computer network using the patient identification presented by the patient;
c. a patient presenting to a healthcare provider computer, in association with healthcare services performed by the associated healthcare provider, a patient identification indicia associated with the patient,
d. the healthcare provider computer transmitting to the healthcare management server computer a query comprising parameters comprising:
i. the patient identification indicia;
ii. an identification of the healthcare services performed or proposed to be performed by the associated healthcare provider; and
iii. an identification of the healthcare provider performing the healthcare services; and
e. the healthcare management server computer utilizing the query to access the first and second repositories to determine if the parameters of the query are in compliance with one or more of the predetermined compliance rules.

26. The method of claim 25 wherein the compliance rules comprise rules related to healthcare treatment procedures, and wherein the healthcare management server computer determines if the healthcare services proposed to be performed by the healthcare provider identified in the query are in compliance with the healthcare treatment procedures.

27. The method of claim 26 wherein healthcare information associated with the patient identified in the query is utilized by the healthcare management server computer to determine if the healthcare services proposed to be performed by the healthcare provider identified in the query are in compliance with the healthcare treatment procedures.

28. The method of claim 25 further comprising the steps of
a. the healthcare management server computer obtaining insurance information from a healthcare insurer computer and
b. utilizing the insurance information to determine if the parameters of the query are in compliance with one or more of the predetermined compliance rules.

29. The method of claim 28 wherein the insurance information comprises information related to an insurance payment that the healthcare insurance provider agrees to pay for the proposed healthcare services.

30. The method of claim 29 wherein the insurance payment is made by the healthcare insurance provider to the healthcare provider based on the healthcare services rendered by the healthcare provider to the patient.

31. The method of claim 25 wherein the compliance rules comprise rules promulgated by a governmental agency.

32. The method of claim 25 wherein the compliance rules comprise rules promulgated by a healthcare administrative agency.

33. The method of claim 25 further comprising the steps of:
a. the healthcare provider computer retrieving from the healthcare management server computer healthcare information associated with the patient and
b. presenting the healthcare information.

34. The method of claim 25 further comprising the step of providing a plurality of tokens, each of which is associated with a patient, and each of which is encoded with the unique identification indicia for identifying the associated patient.

35. The method of claim 34 wherein the token is a healthcare card.

36. The method of claim 35 wherein the healthcare card is a card comprising a magnetic stripe encoded with the patient identification indicia.

37. The method of claim 35 wherein the card is a smart card comprising storage means for storing at least the patient identification indicia.

38. The method of claim 34 wherein the token is an RFID device capable of subdermal implantation.

39. The method of claim 25 further comprising the steps of
a. entering revised healthcare information into means for inputting data associated with the healthcare provider computers;
b. transmitting the revised healthcare information to the healthcare management server computer; and
c. modifying the record in the repository associated with the patient to include the revised healthcare information.

40. The method of claim 25 comprising the further step of providing a third repository of health point account records associated with each of the patients, the health point account records containing a health point account that indicates a number of health points that have been awarded to the patient based on one or more of a plurality of health-related criteria.

41. The method of claim 40 wherein health points are awarded to a patient for participating in a positive health-related activity.

42. The method of claim 40 wherein health points are awarded to a patient for not participating in a negative health-related activity.

43. The method of claim 40 wherein health points are awarded to a patient for maintaining a predetermined level of health.

44. The method of claim 40 wherein multiples of health points are accumulated in the health point account.

45. The method of claim 40 wherein a patient may redeem accumulated health points from the associated health point account in exchange for one of a plurality of available benefits.

46. The method of claim 40 wherein the plurality of available benefits comprise reduced insurance premiums.

47. The method of claim 25 further comprising the step of providing a third party financial services entity interoperable with the healthcare management server computer, said third party financial services entity functioning to make payment to the healthcare provider based on the healthcare services rendered by the healthcare provider to the patient.
